(19) United States
(12) Patent Application Publication
(10) Pub. No.: US 2013/0336220 A1
(43) Pub. Date: Dec. 19, 2013

(54) Single Carrier Cell Aggregation

(71) Applicants: Christian Mahr, Ulm (DE); Peter Skov, Beijing (CN); Chunli Wu, Beijing (CN); Lilei Wang, Beijing (CN)

(72) Inventors: Christian Mahr, Ulm (DE); Peter Skov, Beijing (CN); Chunli Wu, Beijing (CN); Lilei Wang, Beijing (CN)

(73) Assignee: Nokia Siemens Networks Oy, Espoo (FI)

(21) Appl. No.: 13/979,481

(22) PCT Filed: Jan. 12, 2012
(86) PCT No.: PCT/EP12/50454

§ 371 Date: Aug. 30, 2013

(30) Foreign Application Priority Data
Jan. 14, 2011 (EP) 11000270.6

(51) Int. Cl. H04W 74/08

(52) U.S. Cl. CPC H04W 74/08
USPC 370/328

(57) ABSTRACT

It is provided an apparatus, including first receiving means adapted to receive a first signal from a first cell on a first carrier of a cellular network; second receiving means adapted to receive a second signal from a second cell on the first carrier, wherein the first cell is different from the second cell; combining means adapted to combine the first signal and the second signal to a single incoming data unit of a radio link control layer of the cellular network.

### FIELD OF THE INVENTION

The present invention relates to an apparatus, a method, a system, and a computer program product related to cell aggregation. More particularly, the present invention relates to an apparatus, a method, a system, and a computer program product for single carrier cell aggregation.

### BACKGROUND OF THE INVENTION

The present application is in the context of operation of a long-term evolution (LTE) network. A train backhaul scenario, where both the eNodeB (eNB) and the train have directional antennas, is one of the use cases of an LTE system. When there are directional antennas at both receiver and transmitter there will be areas along the track where two strong links can be created: One link between the antenna on the train pointing forward and the site in front of the train, and one link between the antenna on the train pointing backwards to the site at the back of the train (see FIG. 1).

FIG. 1 shows a scenario, where the backward directed antenna of the train communicates with antenna 1 of a base station (BS). After the train has moved to the right, the forward directed antenna of the train communicates with antenna 2 of the base station.

One of the design criteria for both high speed packet access (HSPA) and LTE was to reduce the interaction between cells as much as possible. So LTE release 9 does not support transmission from multiple cells to the same user equipment (UE). In LTE release 10, the 3^{rd} generation partnership project (3GPP) has agreed to support carrier aggregation (CA). This feature allows one user equipment (UE; e.g., as in the present case a train access unit (TAU)) to receive data from multiple carriers. Thus, the effective transmission bandwidth of LTE systems is increased up to 100 MHz.

According to LTE release 10, carrier aggregation is done according to the principle of “aggregation of serving cells”. This means that a UE supporting carrier aggregation supports transmission/reception on multiple carriers from multiple cells. However, aggregation of cells on the same carrier is not considered.

Multi-cell operation on same carrier is known in wideband code division multiplex access (WCDMA) as soft handover and for LTE it has been discussed under the heading of Coordinated Multipoint Transmission and Reception (COMP). According to these concepts, control happens from one serving cell and data transmission can be extended to multiple cells.

### SUMMARY OF THE INVENTION

It is an object of the present invention to improve the prior art.

According to a first aspect of the invention, there is provided an apparatus, comprising first receiving means adapted to receive a first signal from a first cell on a first carrier of a cellular network; second receiving means adapted to receive a second signal from a second cell on the first carrier, wherein the first cell is different from the second cell; combining means adapted to combine the first signal and the second signal to a single incoming data unit of a radio link control layer of the cellular network.

In the apparatus, the combining means may comprise decoding means adapted to decode the first signal to a first data unit and to decode the second signal to a second data unit; and multiplexing means adapted to multiplex the first data unit and the second data unit to the incoming data unit.

In the apparatus, the first signal may be received from a first direction, the second signal may be received from a second direction, and the first direction may be different from the second direction.

In the apparatus, the first receiving means may comprise a first directive antenna; and the second receiving means may comprise a second directive antenna differently oriented than the first directive antenna.

In the apparatus, the first receiving means and the second receiving means may be additionally adapted to receive the first signal from the first direction and the second signal from the second direction, respectively, on the first carrier and a third carrier different from the first carrier, wherein the third carrier is aggregated with the first carrier.

The apparatus may further comprise splitting means adapted to split an outgoing data unit of the radio link control layer to be transmitted into a third signal and a fourth signal of the physical layer; first transmitting means adapted to transmit the third signal into the first cell on a second carrier; second transmitting means adapted to transmit the fourth signal into the second cell on the second carrier; first handling means adapted to handle a first timing advance for the receiving and transmitting in the cell; and second handling means adapted to handle a second timing advance for the receiving and transmitting in the second cell.

In the apparatus, the splitting means may comprise demultiplexing means adapted to demultiplex the outgoing data unit into a first data unit and a second data unit; and coding means adapted to code the first data unit to the third signal and to code the second data unit to the fourth signal.

In the apparatus, the first cell and the second cell may belong to a same base station.

In the apparatus, the first signal and the second signal may comprise a first control signal and a second control signal, respectively, and the first control signal and the second control signal may provide different instructions for carrying out the decoding by the decoding means.

In the apparatus, a transmission mode of the first signal may be different from a transmission mode of the second signal.

According to a second aspect of the invention, there is provided an apparatus, comprising first receiving processor adapted to receive a first signal from a first cell on a first carrier of a cellular network; second receiving processor adapted to receive a second signal from a second cell on the first carrier, wherein the first cell is different from the second cell; combining processor adapted to combine the first signal and the second signal to a single incoming data unit of a radio link control layer of the cellular network.

In the apparatus, the combining processor may comprise decoding processor adapted to decode the first signal to a first data unit and to decode the second signal to a second data unit; and multiplexing processor adapted to multiplex the first data unit and the second data unit to the incoming data unit.

In the apparatus, the first signal may be received from a first direction, the second signal may be received from a second direction, and the first direction may be different from the second direction.

In the apparatus, the first receiving processor may comprise a first directive antenna; and the second receiving processor may comprise a second directive antenna differently oriented than the first directive antenna.

In the apparatus, the first receiving processor and the second receiving processor may be additionally adapted to receive the first signal from the first direction and the second signal from the second direction, respectively, on the first carrier and a third carrier different from the first carrier, wherein the third carrier is aggregated with the first carrier.

The apparatus may further comprise splitting processor adapted to split an outgoing data unit of the radio link control layer to be transmitted into a third signal and a fourth signal of the physical layer; first transmitting processor adapted to transmit the third signal into the first cell on a second carrier; second transmitting processor adapted to transmit the fourth signal into the second cell on the second carrier; first handling processor adapted to handle a first timing advance for the receiving and transmitting in the cell; and second handling processor adapted to handle a second timing advance for the receiving and transmitting in the second cell.

In the apparatus, the splitting processor may comprise demultiplexing processor adapted to demultiplex the outgoing data unit into a first data unit and a second data unit; and coding processor adapted to code the first data unit to the third signal and to code the second data unit to the fourth signal.

In the apparatus, the first cell and the second cell may belong to a same base station.

In the apparatus, the first signal and the second signal may comprise a first control signal and a second control signal, respectively, and the first control signal and the second control signal may provide different instructions for carrying out the decoding by the decoding processor.

In the apparatus, a transmission mode of the first signal may be different from a transmission mode of the second signal.

According to a third aspect of the invention, there is provided an apparatus, comprising splitting means adapted to split a single outgoing data unit of a radio link control layer of a cellular network into a first signal and a second signal; first transmitting means adapted to transmit the first signal to a terminal device to a first cell on a first carrier of a cellular network; and second transmitting means adapted to transmit the second signal to the terminal device to a second cell on the first carrier, wherein the first cell is different from the second cell.

In the apparatus, the splitting means may comprise demultiplexing means adapted to demultiplex the outgoing data unit into a first data unit and a second data unit; and coding means adapted to code the first data unit to the first signal and to code the second data unit to the second signal.

In the apparatus, the first transmitting means may comprise a first antenna; and the second transmitting means may comprise a second antenna spatially separated from the first antenna.

In the apparatus, the first antenna and the second antenna may be directive antennas directed into different directions.

In the apparatus, the first transmitting means and the second transmitting means may be additionally adapted to transmit the first signal by the first antenna and the second signal by the second antenna, respectively, on the first carrier and a third carrier different from the first carrier, wherein the third carrier is aggregated with the first carrier.

The apparatus may further comprise first receiving means adapted to receive a third signal from the first cell on a second carrier; second receiving means adapted to receive a fourth signal from the second cell on the second carrier; decoding means adapted to decode the third signal to a third data unit and to decode the fourth signal to a fourth data unit; multiplexing means adapted to multiplex the third data unit and the fourth data unit to a new single incoming data unit of the radio link control layer; first handling means adapted to handle a first timing advance for the receiving and transmitting in the first cell; and second handling means adapted to handle a second timing advance for the receiving and transmitting in the second cell.

In the apparatus, the first cell and the second cell may belong to a same base station.

In the apparatus, the first signal and the second signal may comprise a first control signal and a second control signal, respectively, and wherein the first control signal and the second control signal may provide different instructions about the coding by the coding means.

In the apparatus, a transmission mode of the first signal may be different from a transmission mode of the second signal.

According to a fourth aspect of the invention, there is provided an apparatus, comprising splitting processor adapted to split a single outgoing data unit of a radio link control layer of a cellular network into a first signal and a second signal; first transmitting processor adapted to transmit the first signal to a terminal device to a first cell on a first carrier of a cellular network; and second transmitting processor adapted to transmit the second signal to the terminal device to a second cell on the first carrier, wherein the first cell is different from the second cell.

In the apparatus, the splitting processor may comprise demultiplexing processor adapted to demultiplex the outgoing data unit into a first data unit and a second data unit; and coding processor adapted to code the first data unit to the first signal and to code the second data unit to the second signal.

In the apparatus, the first transmitting processor may comprise a first antenna; and the second transmitting processor may comprise a second antenna spatially separated from the first antenna.

In the apparatus, the first antenna and the second antenna may be directive antennas directed into different directions.

In the apparatus, the first transmitting processor and the second transmitting processor may be additionally adapted to transmit the first signal by the first antenna and the second signal by the second antenna, respectively, on the first carrier and a third carrier different from the first carrier, wherein the third carrier is aggregated with the first carrier.

The apparatus may further comprise first receiving processor adapted to receive a third signal from the first cell on a second carrier; second receiving processor adapted to receive a fourth signal from the second cell on the second carrier; decoding processor adapted to decode the third signal to a third data unit and to decode the fourth signal to a fourth data unit; multiplexing processor adapted to multiplex the third data unit and the fourth data unit to a new single incoming data unit of the radio link control layer; first handling processor adapted to handle a first timing advance for the receiving and transmitting in the first cell; and second handling processor adapted to handle a second timing advance for the receiving and transmitting in the second cell.

In the apparatus, the first cell and the second cell may belong to a same base station.

In the apparatus, the first signal and the second signal may comprise a first control signal and a second control signal, respectively, and wherein the first control signal and the second control signal may provide different instructions about the coding by the coding processor.

In the apparatus, a transmission mode of the first signal may be different from a transmission mode of the second signal.

According to a fifth aspect of the invention, there is provided a base station, comprising base station means adapted to provide a base station functionality of the cellular network; and an apparatus according to any of the first and third aspects.

According to a sixth aspect of the invention, there is provided a base station, comprising base station processor adapted to provide a base station functionality of the cellular network; and an apparatus according to any of the second and fourth aspects.

According to a seventh aspect of the invention, there is provided a terminal apparatus, comprising terminal means for providing a terminal function of the cellular network; and an apparatus according to any of the first and third aspects.

According to an eighth aspect of the invention, there is provided a terminal apparatus, comprising terminal processor for providing a terminal function of the cellular network; and an apparatus according to any of the second and fourth aspects.

The terminal apparatus according to the seventh or eighth aspects may comprise a train access unit.

According to a ninth aspect of the invention, there is provided a system, comprising terminal apparatus according to any of the first and second aspects; and base station apparatus according to any of the third and fourth aspects; wherein the first cell of the base station apparatus comprises the first cell of the terminal apparatus; the second cell of the base station apparatus comprises the second cell of the terminal apparatus; the first carrier of the base station apparatus comprises the first carrier of the terminal apparatus; the first signal of the base station apparatus comprises the first signal of the terminal apparatus; and the second signal of the base station comprises the second signal of the terminal apparatus.

According to a tenth aspect of the invention, there is provided a method, comprising receiving a first signal from a first cell on a first carrier of a cellular network; receiving a second signal from a second cell on the first carrier, wherein the first cell is different from the second cell; combining the first signal and the second signal to a single incoming data unit of a radio link control layer of the cellular network.

The method may be a method of carrier aggregation.

In the method, the combining may comprise decoding the first signal to a first data unit and the second signal to a second data unit; and multiplexing the first data unit and the second data unit to the incoming data unit.

In the method, the first signal may be received from a first direction, the second signal may be received from a second direction, and the first direction may be different from the second direction.

In the method, the first signal may be received by a first directive antenna; and the second signal may be received by a second directive antenna differently oriented than the first directive antenna.

The method may further comprise receiving the first signal from the first cell and the second signal from the second cell, respectively, on the first carrier and a third carrier different from the first carrier, wherein the third carrier is aggregated with the first carrier.

The method may further comprise splitting an outgoing data unit of the radio link control layer to be transmitted into a third signal and a fourth signal of the physical layer; transmitting the third signal into the first cell on a second carrier; transmitting the fourth signal into the second cell on the second carrier; handling a first timing advance for the receiving and transmitting in the cell; and handling a second timing advance for the receiving and transmitting in the second cell.

In the method, the splitting may comprise demultiplexing the outgoing data unit into a first data unit and a second data unit; and coding the first data unit to the third signal and the second data unit to the fourth signal.

In the method, the first cell and the second cell may belong to a same base station.

In the method, the first signal and the second signal may comprise a first control signal and a second control signal, respectively, and the first control signal and the second control signal may provide different instructions for carrying out the decoding.

In the method, a transmission mode of the first signal may be different from a transmission mode of the second signal.

According to an eleventh aspect of the invention, there is provided a method, comprising splitting a single outgoing data unit of a radio link control layer of a cellular network into a first signal and a second signal; transmitting the first signal to a terminal device to a first cell on a first carrier of a cellular network; and transmitting the second signal to the terminal device to a second cell on the first carrier, wherein the first cell is different from the second cell.

The method may be a method of carrier aggregation.

In the method, the splitting may comprise demultiplexing the outgoing data unit into a first data unit and a second data unit; and coding the first data unit to the first signal and the second data unit to the second signal.

In the method, the transmitting of the first signal may be performed via a first antenna; and the transmitting of the second signal may be performed via a second antenna spatially separated from the first antenna.

In the method, the first antenna and the second antenna may be directive antennas directed into different directions.

The method may further comprise transmitting the first signal into the first cell and the second signal into the second cell, respectively, on the first downlink carrier and a second downlink carrier different from the first downlink carrier, wherein the second downlink carrier is aggregated with the first downlink carrier.

The method may further comprise receiving a third signal from the first cell on a second carrier; receiving a fourth signal from the second cell on the second carrier; decoding the third signal to a third data unit and the fourth signal to a fourth data unit; multiplexing the third data unit and the fourth data unit to a new single incoming data unit of the radio link control layer; handling a first timing advance for the receiving and transmitting in the first cell; and handling a second timing advance for the receiving and transmitting in the second cell.

In the method, the first cell and the second cell may belong to a same base station.

In the method, the first signal and the second signal may comprise a first control signal and a second control signal, respectively, and wherein the first control signal and the second control signal may provide different instructions about the coding by the coding means.

In the method, a transmission mode of the first signal may be different from a transmission mode of the second signal.

According to a twelfth aspect of the invention, there is provided computer program product including a program comprising software code portions being arranged, when run on a processor of an apparatus, to perform the method according to any one of the tenth and eleventh aspects.

The computer program product may comprise a computer-readable medium on which the software code portions are stored, and/or wherein the program is directly loadable into a memory of the processor.

Thus, carrier aggregation may be used to aggregate signals transmitted from different sites on the same carrier. The different sites may belong to different cells. Hereinafter, this is called single carrier cell aggregation.

Instead of by different receiving directions, the signals of the different cells may be distinguished by different polarizations, different time schedules, different coding schemes etc. That is, according to embodiments of the present invention, the “dimension” frequency of multi-carrier cell aggregation is substantially replaced by a “dimension” space, time, coding, polarization, etc.

For example, according to one use case, the UE may have multiple directive antennas so that the links to two or more sites (cells under the control of the same or different eNB) are of good quality. Such a UE may be a train access unit (TAU). By communicating with the train from both sides, it is achieved that the two links are fully exploited. Furthermore, as may be seen from the simulation results discussed below, the throughput has much less spatial dependency than according to a conventional scenario with one active link at a time.

The UE may be controlled by independent control commands from the two cells. Thus, the flexibility of signal transmission is enhanced.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a train backhaul scenario according to the prior art;

FIG. 2 shows a train backhaul scenario according to an embodiment of the invention;

FIG. 3 shows an apparatus according to an embodiment of the invention;

FIG. 4 shows a method according to an embodiment of the invention;

FIG. 5 shows an apparatus according to an embodiment of the invention;

FIG. 6 shows a method according to an embodiment of the invention;

FIG. 7 shows a train backhaul scenario according to the prior art;

FIG. 8 shows a train backhaul scenario according to the prior art;

FIG. 9 shows a train backhaul scenario according to an embodiment of the invention; and

FIGS. 10 to 15 show simulation results.

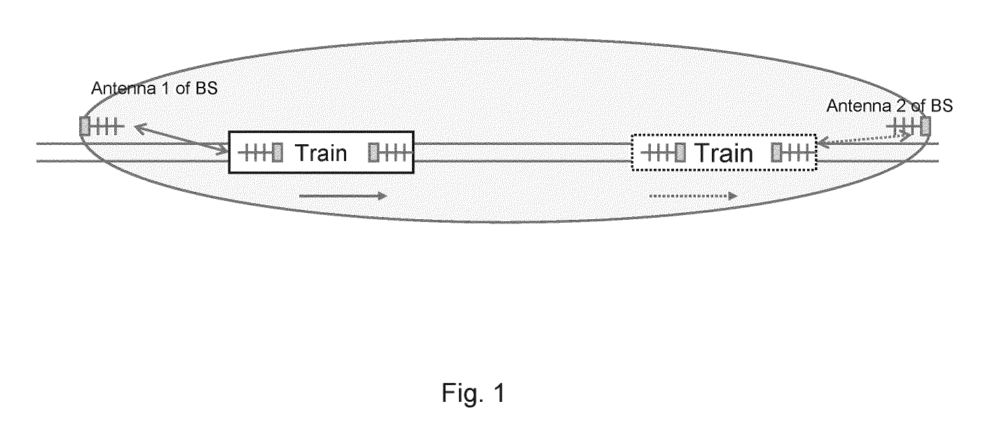

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

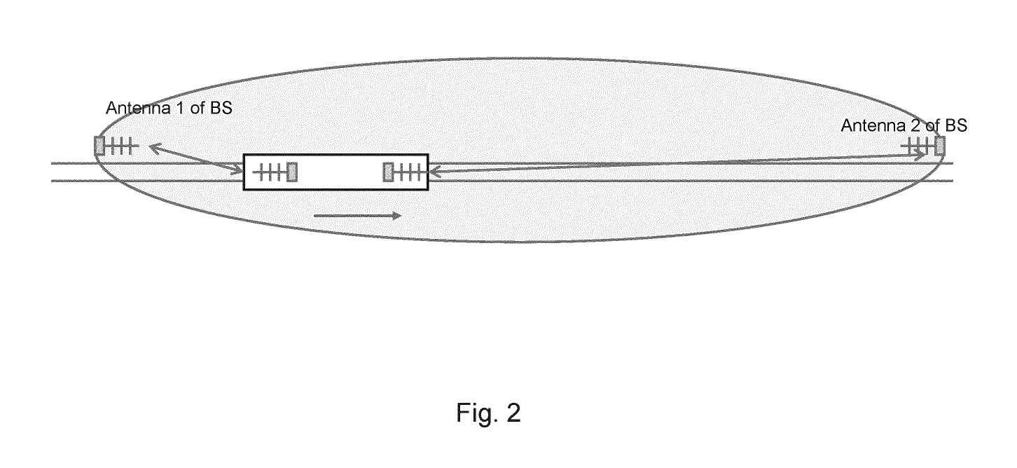

According to an embodiment of the invention, adjacent cells or eNBs build a cell set to feed into one train. FIG. 2 shows a train backhaul scenario according to an embodiment of the invention, wherein the backward directed antenna of the train communicates with one antenna (antenna 1), and the forward directed antenna of the train communicates with another antenna (antenna 2). The antennas may belong to respective different cells, and the cells may belong to the same or to different eNBs.

The scenario may correspond to a kind of “simple CoMP”. In this context, “simple” means that no constructive interference condition at the UE as in coordinated multi-point transmission (CoMP) is required. Thus, the complexity of the scenario is considerably simpler than for CoMP. For example, basically the existing carrier aggregation (CA) protocol may be used to establish the second link. Correspondingly to multiple carrier aggregation, parallel independent hybrid adaptive repeat and request (HARQ) links may be used. The handling including a handover may be performed in the same way as with multiple carrier aggregation.

More in detail, at the base station, a data unit of the radio link control (RLC) layer may be split into different signals of the physical layer for each of the cells of the cell set. The signals, in particular physical downlink control channel (PDCCH) and physical downlink shared channel (PDCSH), may be separately transmitted to the UE. There, the received signals from the two antennas may be combined to a data unit of the RLC layer.

Preferably, as in multiple carrier aggregation, the splitting and combining may take place by a formal (de-)multiplexer between the hybrid adaptive repeat and request (HARQ) layer and the RLC layer. The HARQ layer belongs to the medium access control (MAC) layer between the physical layer and the RLC layer. That is, the different signals may be separately decoded into data units and then multiplexed to obtain a data unit of the RLC layer. Thus, compared to CoMP where combining is performed in the physical layer, by moving the combining to the RLC layer, coordination effort between the base stations is reduced.

In some embodiments, where the different antennas belong to different cells, the cellID may be used to transport information of the antenna to higher layers at which and/or below which the splitting and combining takes place.

In some embodiments, the (de-)multiplexer may take the actual capacity, quality etc. of each link into account when deciding on the load for each link. This is in particular advantageous if the user terminal moves between the antennas. In other embodiments, the relative load of the links may be predetermined.

Preferably, it is ensured that each of the antennas on the receiving side (user equipment for downlink) receives mostly only one of the two physical signals. For example, this may be achieved by directional antennas or by directional shielding. On the transmitting side (base station for downlink), directional sending may be preferred, too. However, e.g. in case of a railway track, the transmitting angle may be much larger than for the receiving side in order to cover a larger area or a longer part of the track if it is not straight.

In some embodiments, instead of single carrier aggregation of the downlink, single carrier aggregation is correspondingly applied to the uplink from the terminal to the base station.

In some embodiments, single carrier aggregation is used not only for one of the downlink and the uplink but for both of them. Then, a separate timing advance (TA) handling for each of the two cells may be employed.

Using the single carrier cell aggregation is a smart way of making multi-cell transmissions, as discussed e.g. for coordinated multi-point transmission (CoMP). An advantage of single carrier cell aggregation is that both data and control signaling may be transmitted from multiple cells, which is not possible with CoMP.

For some embodiments of the invention, one or more of the following implementation details may apply:

For measurement configuration, cell id may be used and the report may include all measurements from all serving cells.

The carrier indicator field (CIF) used in PDCCH may be based on cell id.

The physical cell id for different aggregated cells may be set differently such that there is no interference randomization problem even if two aggregated carriers interfere.

Single carrier aggregation may be applied for downlink (DL) only or for both DL and uplink (UL). In the 1^{st} case, link specific timing advance (TA) handling is not required. If single carrier aggregation is used in the uplink, too, a separate timing advance may be used for the additional link. In this case the initial random access procedure (an existing procedure from handover procedure) may be used for initially settings of the TA. TA maintenance may be provided with existing MAC header information on each link.

In some embodiments, multiple carrier aggregation (e.g. on different frequencies) may be applied together with single carrier aggregation. Single carrier aggregation may be applied to all available carriers.

Preferably, aggregated cells of single carrier aggregation are handled within the same eNB. It is common practice that one eNB may handle more than one cell.

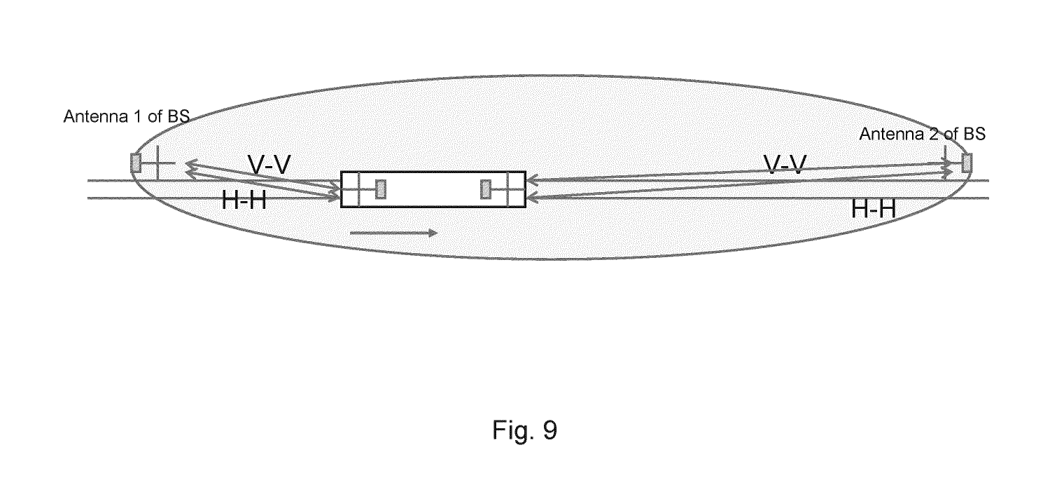

Single carrier cell aggregation may be combined with multiple input-multiple output (MIMO) techniques such as cross polar antennas. For example, each of the two directional antennas of FIG. 2 may be a cross polar antenna. Single carrier cell aggregation may take place for the two vertically (V) polarized antennas and for the two horizontally (H) polarized antennas. The combination of the data units obtained from the vertically polarized antennas and the horizontally polarized antennas is performed according to known MIMO techniques. An embodiment with such a configuration is shown in FIG. 9.

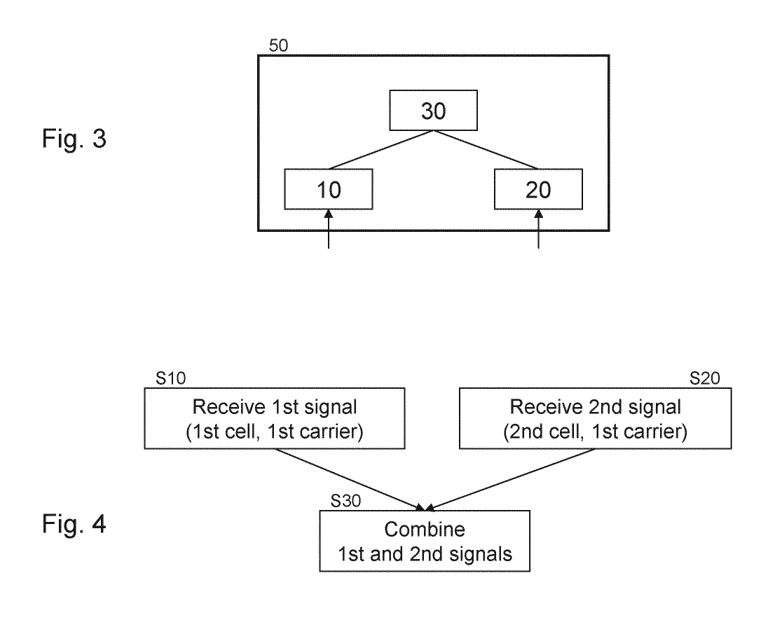

FIG. 3 shows an apparatus 50 according to an embodiment of the invention. The apparatus 50 may be a terminal such as a train access unit. FIG. 4 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus 50 comprises a first receiving means 10, a second receiving means 20, and a combining means 30.

The first receiving means 10 is adapted to receive a signal of the physical layer from a first cell on a specific downlink carrier (S10). The second receiving means 20 is adapted to receive a signal of the physical layer from a second cell on the same specific downlink carrier as the first receiving means 10 (S20). The second cell may be different from the first cell.

The combining means 30 correlates the received signals of the first and second receiving means (S30) into a data unit of the RLC layer.

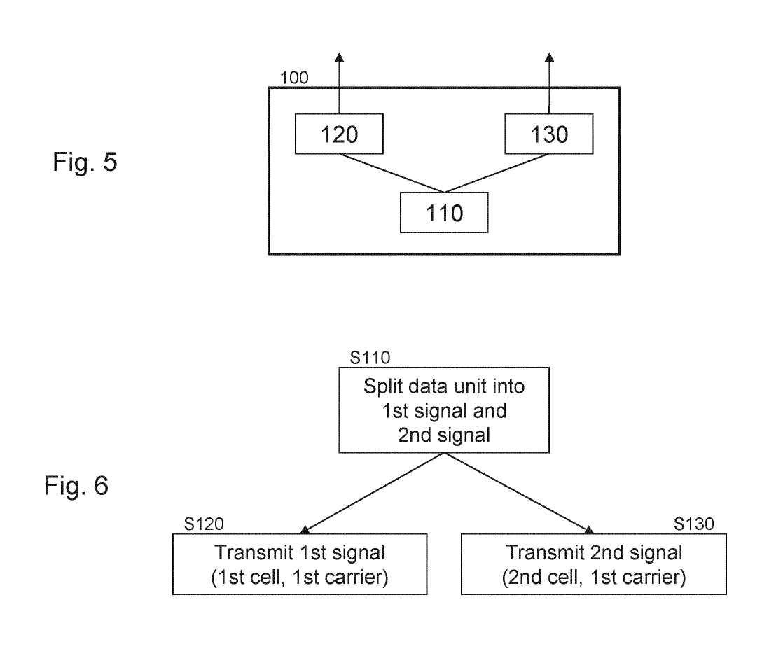

FIG. 5 shows an apparatus 100 according to an embodiment of the invention. The apparatus 100 may be a base station such as an eNB. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus 100 comprises a splitting means 110, a first transmitting means 120, and a second transmitting means 130.

The splitting means 110 splits a data unit of the RLC layer intended for a terminal into first and second signals of the physical layer (S110). The first signal is transmitted by the first transmitting means 120 via a first antenna on a specific downlink carrier (S120). The second signal is transmitted by the second transmitting means 130 via a second antenna on the same downlink carrier as the first data (S120). The first antenna may be spatially separated from the second cell. The transmissions of the first and second control signals may be independent from each other. In particular, they need not to be coordinated such that a constructive interference condition is fulfilled at the terminal.

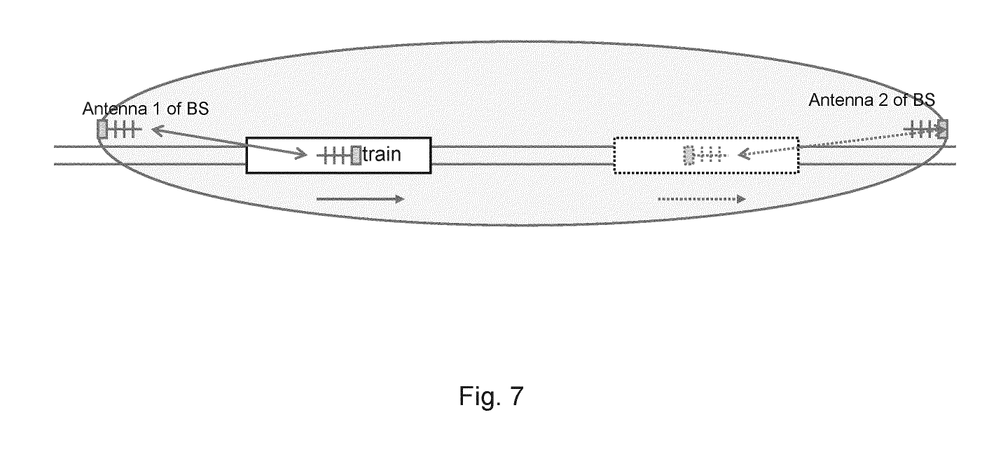

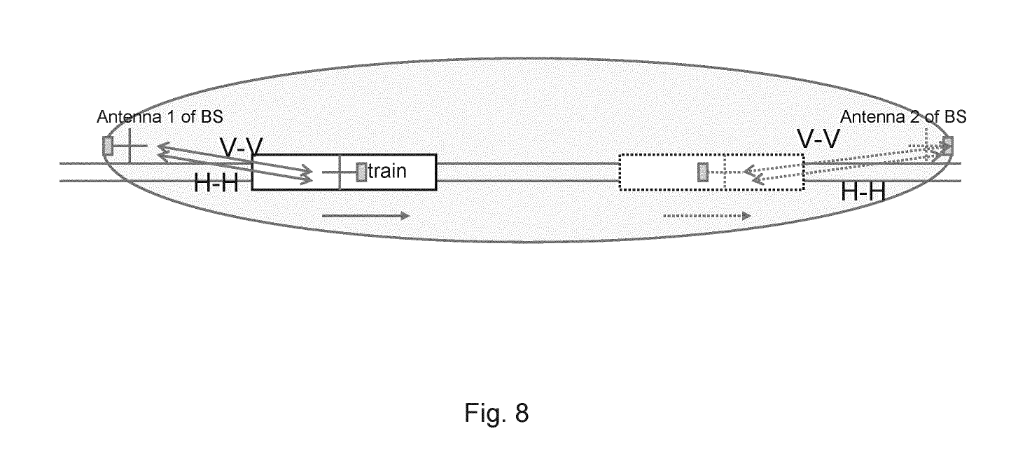

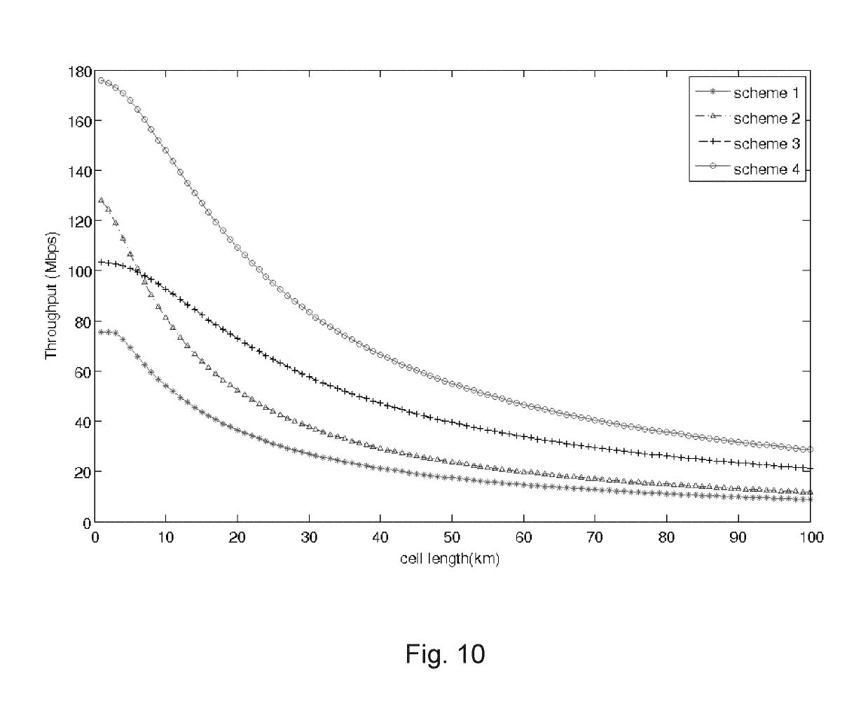

FIGS. 10 to 15 show simulation results of four different scenarios (schemes 1 to 4). Schemes 1 and 2 are depicted in FIGS. 7 and 8, respectively, scheme 3 is depicted in FIG. 2, and scheme 4 is depicted in FIG. 9.

The key features of the respective schemes are as follows:

### Scheme 1 (FIG. 7):

Train has one antenna
The base station (BS) has two directional antennas, one of which is on left side and another is on right side
Only one directional antenna of train communicates with BS;
Transmission switches from left link to right link when train moves closely to antenna 2 of BS;

### Scheme 2 (FIG. 8):

One cross polar antenna on the train (totally 2 antennas, e.g. H: horizontally polarized; V: vertically polarized);
BS has one cross polar antenna on the left side and one on the right side (totally four antennas);
In the simulation, data transmission between co-polar antennas, such as vertical-to-vertical and horizontal-to-horizontal is mainly considered;
There is some interference between cross-polar antennas;
Transmission switches from left two links to right two links when train moves closely to antenna 2 of BS.

### Scheme 3 (FIG. 2):

Train has two directional antennas. One is directed to the front and another to the back;
BS has two directional antennas, one of which is on left side and another is on right side;
The two links of the train are working at the same time;
There is some interference between the two links;
No transmission switch issue.

### Scheme 4 (FIG. 9):

Two cross polar antennas on the train (totally 4 antennas). One cross polar antenna is directed to the front and another cross polar antenna is directed to the back;
BS has one cross polar antenna on the left and one on the right side (totally four antennas);
The two Cross polar antennas of the train communicate with BS at the same time;
Totally four links are working: link1_VV, link1_HH, link2_VV and link2_HH, wherein link1_VV means link to antenna 1, vertical polarized antenna of train with vertically polarized antenna of BS etc.;
For each link, the interference comes from the other three links.

The simulation assumptions are as follows:
Two cells and one train
2 G Hz for center frequency and 20M Hz bandwidth
Only large-scale fading is considered
XPR=20 dB, Front-back antenna gain=20 dB, directional antenna gain=14 dB
No RRM
Path loss formula (3GPP UMa LoS)
PL=22.0 log 10(d)+28.0+20 log 10(fc)
Turned Shannon formula

$$C = α log 2 ( 1 + \frac{SINR}{SINR\_eff} ) ( bps \text{/} hz )$$

$$α = 0.57 , SINR\_eff = 2$$

SINR is limited by EVM (25 dB) and throughput is limited by max TB size (75.376 Mbps, specified by 3GPP 36.213)

FIG. 10 shows the simulated throughput in dependence of the distance between the antennas for the four schemes.

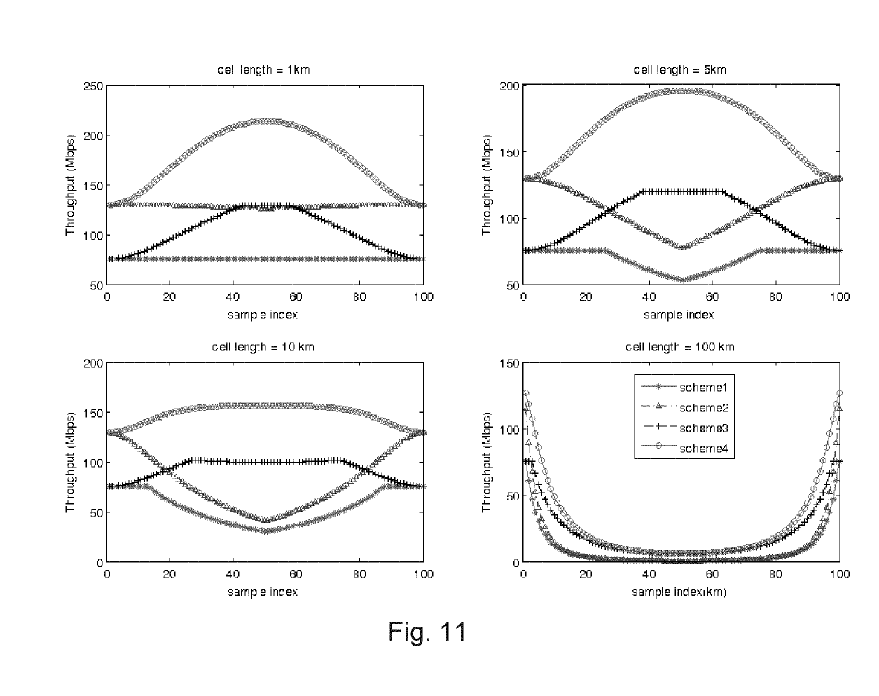

FIG. 11 shows the simulated throughput in dependence of the sample index for different antenna distances for the four schemes. The sample index indicates the distance of the UE from antenna 1 expressed as a percentage of the respective distance between the antennas.

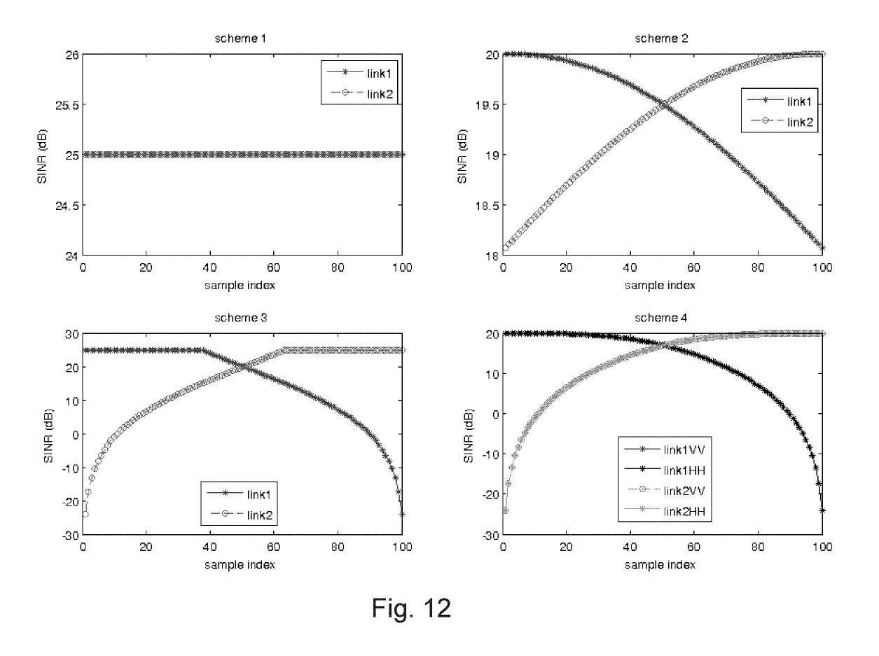

FIG. 12 shows the simulated signal to interference plus noise ratio (SINR) in dependence of the sample index for the two links for the four schemes, wherein the antenna distance is 1 km.

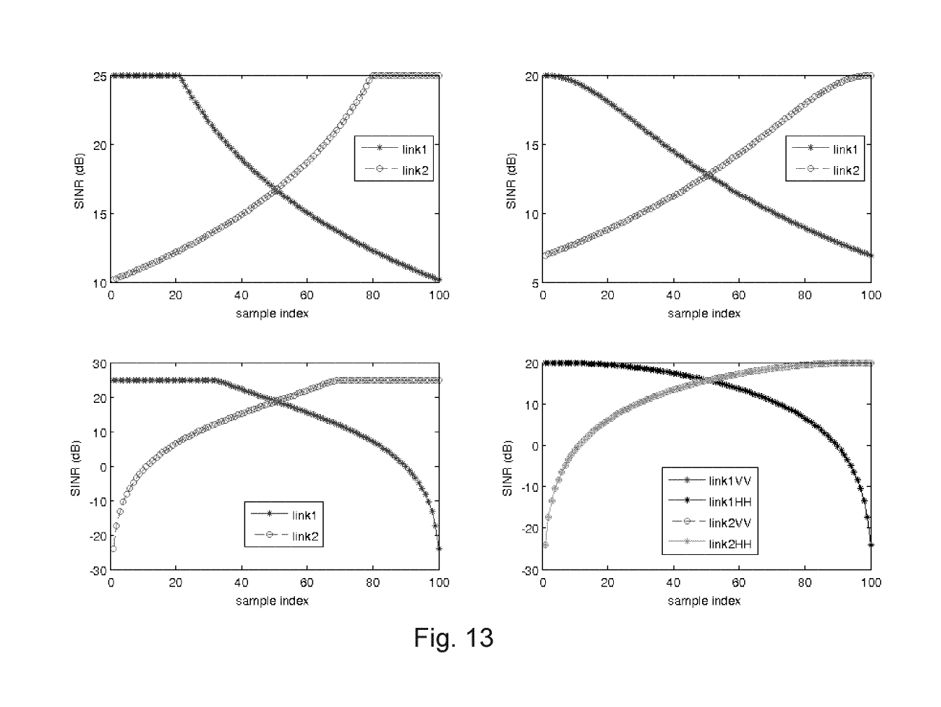

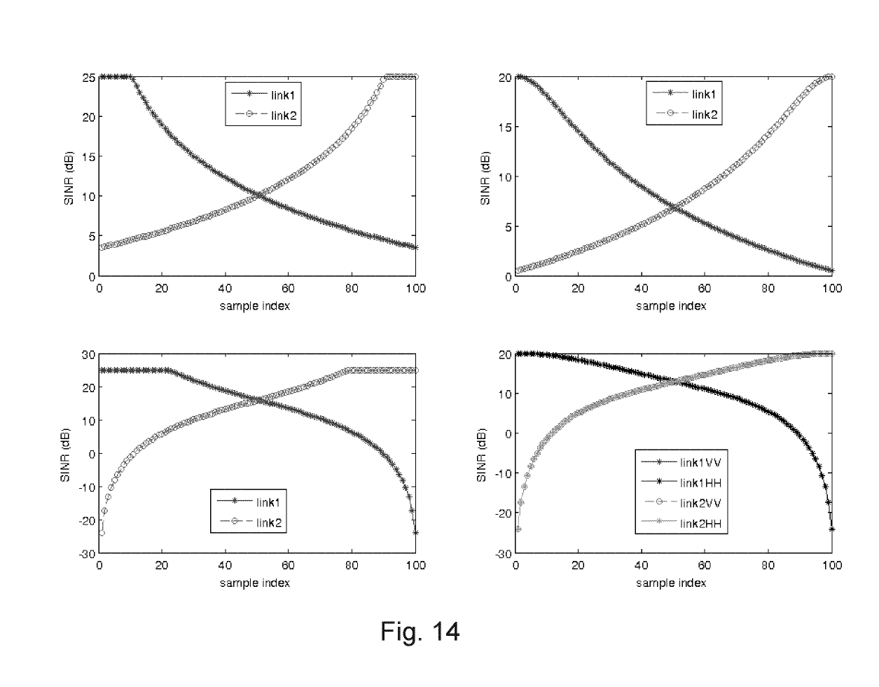

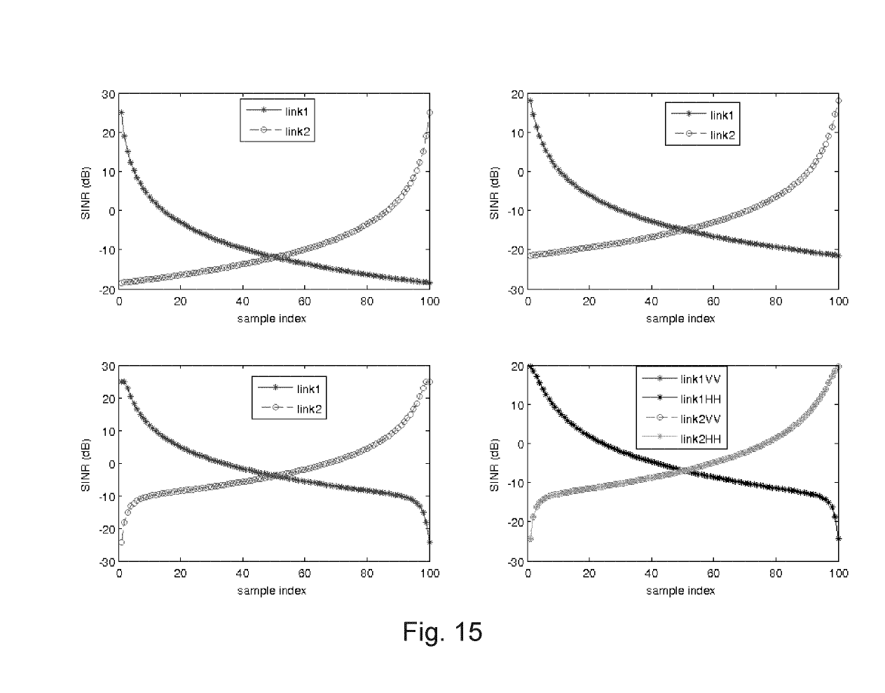

FIGS. 13 to 15 correspond to FIG. 12, wherein the antenna distances are 5 km (FIG. 13), 10 km (FIG. 14), and 100 km (FIG. 15), respectively.

As a result of these simulations, it may be concluded that the coverage ability is different for the four schemes, wherein scheme 4 is superior to scheme 3 which is superior to scheme 2 which is superior to scheme 1 (scheme 4>scheme 3>scheme 2>scheme 1).

Furthermore, as may be seen from FIGS. 11 to 15, the variation of the throughput is much less with single carrier cell aggregation than without. The throughput and the SINR in the middle between the antennas may be even superior to that close to the antennas.

Embodiments of the invention are described with respect to a train access unit (TAU). However, embodiments of the invention may be employed in other terminals than TAUs such as a user equipment (UE).

Embodiments of the invention are described with respect to aggregation of one carrier of two cells. However, in other embodiments, more than two cells with the same carrier may be aggregated.

Embodiments of the invention are described with respect to an

LTE network. However, embodiments of the invention may be employed in other cellular networks such as universal mobile telecommunication system (UMTS), global packet radio system (GPRS), or LTE-advanced (LTE-a).

If not otherwise stated or otherwise made clear from the context, the statement that two entities are different means that they are differently addressed in the communication network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a terminal, or a component thereof, an apparatus embodying the same, a method for controlling and/or operating the same, and computer program(s) controlling and/or operating the same as well as mediums carrying such computer program(s) and forming computer program product(s). Further exemplary embodiments of the present invention provide, for example a base station, or a component thereof, an apparatus embodying the same, a method for controlling and/or operating the same, and computer program(s) controlling and/or operating the same as well as mediums carrying such computer program(s) and forming computer program product(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-44. (canceled)

45. Apparatus, comprising
first receiving means adapted to receive a first signal from a first cell on a first carrier of a cellular network;
second receiving means adapted to receive a second signal from a second cell on the first carrier, wherein the first cell is different from the second cell;
combining means adapted to combine the first signal and the second signal to a single incoming data unit of a radio link control layer of the cellular network.

46. The apparatus according to claim 45, wherein the combining means comprises
decoding means adapted to decode the first signal to a first data unit and to decode the second signal to a second data unit; and
multiplexing means adapted to multiplex the first data unit and the second data unit to the incoming data unit.

47. The apparatus according to claim 45, wherein the first receiving means comprises a first directive antenna; and the second receiving means comprises a second directive antenna differently oriented than the first directive antenna.

48. The apparatus according to claim 45, wherein the first receiving means and the second receiving means are additionally adapted to receive the first signal from the first direction and the second signal from the second direction, respectively, on the first carrier and a third carrier different from the first carrier, wherein the third carrier is aggregated with the first carrier.

49. The apparatus according to claim 45, further comprising
splitting means adapted to split an outgoing data unit of the radio link control layer to be transmitted into a third signal and a fourth signal of the physical layer;
first transmitting means adapted to transmit the third signal into the first cell on a second carrier;
second transmitting means adapted to transmit the fourth signal into the second cell on the second carrier;
first handling means adapted to handle a first timing advance for the receiving and transmitting in the cell; and
second handling means adapted to handle a second timing advance for the receiving and transmitting in the second cell.

50. Apparatus according to claim 49, wherein the splitting means comprises
demultiplexing means adapted to demultiplex the outgoing data unit into a first data unit and a second data unit; and
coding means adapted to code the first data unit to the third signal and to code the second data unit to the fourth signal.

51. The apparatus according to claim 45, wherein
the first cell and the second cell belong to a same base station.

52. The apparatus according to claim 46, wherein the first signal and the second signal comprise a first control signal and a second control signal, respectively, and wherein the first control signal and the second control signal are providing different instructions for carrying out the decoding by the decoding means.

53. The apparatus according to claim 45, wherein a transmission mode of the first signal is different from a transmission mode of the second signal.

54. Apparatus, comprising
splitting means adapted to split a single outgoing data unit of a radio link control layer of a cellular network into a first signal and a second signal;
first transmitting means adapted to transmit the first signal to a terminal device to a first cell on a first carrier of a cellular network; and
second transmitting means adapted to transmit the second signal to the terminal device to a second cell on the first carrier, wherein the first cell is different from the second cell.

55. The apparatus according to claim 54, wherein the splitting means comprises
demultiplexing means adapted to demultiplex the outgoing data unit into a first data unit and a second data unit; and
coding means adapted to code the first data unit to the first signal and to code the second data unit to the second signal.

56. The apparatus according to claim 54, wherein
the first transmitting means comprises a first antenna; and
the second transmitting means comprises a second antenna spatially separated from the first antenna, and wherein
the first antenna and the second antenna are directive antennas directed into different directions.

57. The apparatus according to claim 54, wherein the first transmitting means and the second transmitting means are additionally adapted to transmit the first signal by the first antenna and the second signal by the second antenna, respectively, on the first carrier and a third carrier different from the first carrier, wherein the third carrier is aggregated with the first carrier.

58. The apparatus according to claim 54, further comprising
first receiving means adapted to receive a third signal from the first cell on a second carrier;
second receiving means adapted to receive a fourth signal from the second cell on the second carrier;
decoding means adapted to decode the third signal to a third data unit and to decode the fourth signal to a fourth data unit;
multiplexing means adapted to multiplex the third data unit and the fourth data unit to a new single incoming data unit of the radio link control layer;
first handling means adapted to handle a first timing advance for the receiving and transmitting in the first cell; and
second handling means adapted to handle a second timing advance for the receiving and transmitting in the second cell.

59. The apparatus according to 54, wherein
the first cell and the second cell belong to a same base station.

60. The apparatus according to claim 56, wherein the first signal and the second signal comprise a first control signal and a second control signal, respectively, and wherein the first control signal and the second control signal are providing different instructions about the coding by the coding means.

61. The apparatus according to claim 54, wherein a transmission mode of the first signal is different from a transmission mode of the second signal.

62. Method, comprising
receiving a first signal from a first cell on a first carrier of a cellular network;
receiving a second signal from a second cell on the first carrier, wherein the first cell is different from the second cell;
combining the first signal and the second signal to a single incoming data unit of a radio link control layer of the cellular network.

63. Method, comprising
splitting a single outgoing data unit of a radio link control layer of a cellular network into a first signal and a second signal;
transmitting the first signal to a terminal device to a first cell on a first carrier of a cellular network; and
transmitting the second signal to the terminal device to a second cell on the first carrier, wherein
the first cell is different from the second cell.

64. A computer program embodied on a computer-readable storage medium, the computer program comprising program code for controlling a process to execute a process, the process comprising:
receiving a first signal from a first cell on a first carrier of a cellular network;
receiving a second signal from a second cell on the first carrier, wherein the first cell is different from the second cell;
combining the first signal and the second signal to a single incoming data unit of a radio link control layer of the cellular network.

65. A computer program embodied on a computer-readable storage medium, the computer program comprising program code for controlling a process to execute a process, the process comprising:
splitting a single outgoing data unit of a radio link control layer of a cellular network into a first signal and a second signal;
transmitting the first signal to a terminal device to a first cell on a first carrier of a cellular network; and
transmitting the second signal to the terminal device to a second cell on the first carrier, wherein
the first cell is different from the second cell.
